(19) United States
(12) Patent Application Publication
(10) Pub. No.: US 2018/0038351 A1
(43) Pub. Date: Feb. 8, 2018

(54) WIND TURBINE WITH IMPROVED COOLING

(71) Applicant: Siemens Aktiengesellschaft, Munchen (DE)

(72) Inventors: Bo Nedergaard Jacobsen, Odder (DK); Peter Hessellund Soerensen, Braestrup (DK)

(21) Appl. No.: 15/657,533

(22) Filed: Jul. 24, 2017

Related U.S. Application Data
(60) Provisional application No. 62/371,388, filed on Aug. 5, 2016.

(30) Foreign Application Priority Data
Aug. 5, 2016 (DE) 102016214543.6
Aug. 5, 2016 (EP) 16182958.5

(51) Int. Cl. F03D 80/60; F03D 9/25; H02K 7/18; H02K 9/06

(52) U.S. Cl. CPC F03D 80/60; H02K 9/06; F03D 9/25; H02K 7/1838

(57) ABSTRACT

A wind turbine including a nacelle supported by a tower, a generator, a rotatable front assembly arranged on a side of the generator facing away from the nacelle, and a cooling system for cooling the generator by feeding cooling air from the rotatable front assembly to the generator is provided. Furthermore, a method of cooling a generator of a wind turbine is described.

### CROSS-REFERENCE TO RELATED APPLICATIONS

This application claims priority to European Application No. EP 16182958.5, German Application No. DE 102016214543.6, and U.S. Application No. 62/371,388, all having a filing date of Aug. 5, 2016, the entire contents of all of which are hereby incorporated by reference.

### FIELD OF TECHNOLOGY

The following relates to the field of wind turbines, in particular to wind turbines comprising a cooling system for cooling the wind turbine generator during operation.

### BACKGROUND

It is known to cool wind turbine generators by feeding cooling air from the nacelle into the generator where it is circulated to cool the coils or windings of the generator.

EP2615299B1 discloses a cooling system of a wind turbine axially transporting cooling air from non-drive-end to drive-end side of the generator-stator via air-ducts running axially through the generator-stator room. Unfortunately, the cooling air arriving at the drive-end sided end windings of the stator is warmer than at the non-drive end sided end windings due to the heated air in the generator-stator room warming up the air in the said air-ducts.

To prevent corrosion in the generator, it is important that the cooling air is sufficiently dry. In order to lower the humidity of the cooling air, a part of the heated return air may be blended with the cooling air from the nacelle as disclosed in EP2806542A.

Therefore, there may be a need for an improved cooling of a wind turbine generator.

### SUMMARY

This need may be met by the subject matter according to the independent claims. Advantageous embodiments are described by the dependent claims.

According to a first aspect of embodiments of the invention which provide a wind turbine comprising (a) a nacelle supported by a tower, (b) a generator, (c) a rotatable front assembly arranged on a side of the generator facing away from the nacelle, and (d) a cooling system for cooling the generator by feeding cooling air from the rotatable front assembly to the generator.

This aspect of embodiments of the invention are based on the idea that cooling air is fed from the rotatable front assembly and into the drive end of the generator, i.e. the part of the generator that is farthest away from the nacelle. Thereby, an efficient cooling of the generator, in particular of the drive end part of the generator, can be obtained.

The nacelle is supported by the tower which is fastened to the ground or sea bottom at its lower end. The nacelle constitutes the rear part of the wind turbine while the rotatable front assembly constitutes the front part (relative to the wind direction). The generator is arranged essentially between the nacelle and the rotatable front assembly in the sense that one side of the generator (the non-drive end) faces or is located within the nacelle while the opposite side of the generator (the drive end) faces the rotatable front assembly. In case of a direct drive (gearless) wind turbine, the generator is usually located between the nacelle and the rotatable front assembly and does not extend into the nacelle. In case of a geared wind turbine, the generator may, at least in part, extend into the nacelle. The rotatable front assembly comprises a number of components which interact to convert wind energy into rotational (mechanical) energy which in turn is converted into electrical energy by the generator.

According to an embodiment of the invention, the rotatable front assembly comprises a front assembly air intake and the cooling air comprises air taken in through the front assembly air intake.

In other words, the cooling air, which the cooling system feeds from the rotatable front assembly to the generator, comprises ambient air taken in through a front assembly air intake.

According to a further embodiment of the invention, the rotatable front assembly comprises a hub, at least one rotor blade mounted on the hub, and a spinner covering the hub.

The at least one rotor blade causes the hub to rotate around an axis (and thereby drive the generator) when incoming wind hits the rotor blade(s). The spinner is a housing or shield that covers the hub in order to protect it from the environment.

According to a further embodiment of the invention, the front assembly air intake is at least partially coincident with an opening in the spinner through which the at least one rotor blade extends.

In other words, ambient air may enter the rotatable front assembly through an opening in the spinner which allows the blade to extend from the hub.

According to a further embodiment of the invention, the front assembly air intake comprises a ring-shaped opening surrounding the at least one rotor blade.

The width of the ring-shaped opening, i.e. the difference between the outer diameter and inner diameter of the ring-shaped opening, is sufficiently large to take in a substantial amount of air and on the same time small enough to assure that larger objects and significant amounts of water (rain) cannot enter the rotatable front assembly. The sum of all air intake openings, i.e. the ring-shaped openings around the blades and the optional ring-shaped opening between stator and hub, may preferably have a total area between 0.4 m² and 1 m², in particular around 0.6 m².

Any water entering the rotatable front assembly is preferably guided through the rotor blades and ejected through openings at the blade tips as a result of the centrifugal force.

According to a further embodiment of the invention, the front assembly air intake comprises an air guide arranged on an outer surface of the spinner.

In other words, ambient air may be guided into the rotatable front assembly through an air guide, such as a duct, arranged on the outer surface of the spinner.

The opening of the air guide is sufficiently large to take in a substantial amount of air and on the same time small enough to assure that larger objects and significant amounts of water (rain) cannot enter the rotatable front assembly. The opening of the air guide may preferably have a total cross-sectional area between 0.1 m² and 0.3 m², in particular around 0.2 m².

According to a further embodiment of the invention, the front assembly air intake comprises an intake filter and/or an intake fan.

The intake filter may for example be a moisture filter, a dirt filter, a salt filter or a combination of such filters.

According to a further embodiment of the invention, the tower comprises a tower air intake located at a base portion of the tower and power cables for transmitting power from the generator to the base portion, wherein the cooling system comprises means for guiding air from the tower air intake to the rotatable front assembly such that the air is heated by the power cables, whereby the cooling air comprises air taken in through the tower air intake. Typically, the electrical losses of the cables are typically in the range between 300 Watt and 500 Watt per meter.

The power cables, in particular power cables transmitting power from the generator down through the tower to transformers and other electrical installations located at the base portion of the tower, will heat the ambient air taken in through the tower air intake as the air is guided upwards through the tower by the guiding means. This heating of the air is mainly produced by the electrical losses of the cables and causes a reduction in the relative humidity of the air. Thus, once the tower air reaches the rotatable front assembly, it will be drier (in the sense that its relative humidity is smaller) than the air surrounding the wind turbine.

Accordingly, the air taken in through the tower air intake and guided upwards by the guiding means will be relatively dry and thus well suited for cooling the generator by itself or for blending with possibly more humid cooling air from other sources.

Furthermore, the tower air may advantageously be mixed with air in the rotatable front assembly origination from one or more different air intakes, such as air intakes corresponding to the above-described front assembly air intakes. In this case, the dry tower air will reduce the relative humidity of the cooling air resulting from the mixing. Accordingly, the tower air may advantageously be used to adjust the relative humidity of the cooling air, thereby reducing the risk of causing corrosion in the stator windings 131.

According to a further embodiment of the invention, the cooling system further comprises a tower fan arranged within the tower.

The tower fan may cause a larger amount of ambient air to be drawn in through the tower air intake.

In some embodiments, more than one tower fan may be arranged at various positions within the tower, e.g. in the vicinity of the tower air intake, close to the upper end of the tower, etc.

According to a further embodiment of the invention, the rotatable front assembly comprises one or more openings facing the generator, the openings being adapted to feed the cooling air to the generator.

The openings may in particular be formed in a rotor front plate between the hub and the generator.

According to a further embodiment of the invention, a filter is arranged in the vicinity of each of the one or more openings, i.e. in such a way that the cooling air passing through the respective opening is filtered before entering the generator.

According to a further embodiment of the invention, the filter arranged in each of the one or more openings is selected from the group consisting of a moisture filter, a dirt filter, and a salt filter.

According to a further embodiment of the invention, the cooling system further comprises one or more front fans arranged in the vicinity of at least one of the one or more openings.

More specifically, a front fan may be arranged in the vicinity of each opening, i.e. on the generator side of the opening, on the hub side of the opening, or within the opening itself. Preferably, each opening is equipped with at least one fan, such that the cooling air from the rotatable front assembly is drawn through the openings and into the generator.

According to a further embodiment of the invention, the cooling system further comprises a rear fan (main fan) arranged at a side of the generator facing away from the rotatable front assembly, the rear fan being adapted to draw the cooling air from the rotatable front assembly through the generator and towards the nacelle.

The rear fan may preferably be arranged within the nacelle at a position close to the generator to draw the cooling air from the rotatable front assembly through the generator and into an exhaust duct extending within the nacelle.

According to a further embodiment of the invention, the cooling system is further adapted to feed additional cooling air from the nacelle to the generator.

In this embodiment, cooling air is drawn into the generator from both sides, i.e. from the side facing the nacelle and from the side facing the rotatable front assembly. Thereby, a uniform cooling of the generator may be obtained.

According to a second aspect of embodiments of the invention which provide a method of cooling a generator of a wind turbine, the wind turbine comprising a nacelle supported by a tower, the generator, and a rotatable front assembly arranged on a side of the generator facing away from the nacelle. The method comprises (a) feeding cooling air from the rotatable front assembly to the generator.

This aspect of embodiments of the invention are based on the same idea as the first aspect discussed above.

According to a further embodiment of the invention, the cooling air comprises air taken in through a front assembly air intake and/or air taken in through a tower air intake.

In other words, the cooling air may consist of air taken in through the front assembly air intake, of air taken in through the tower air intake, or of a blend of air taken in through the front assembly air intake and air taken in through the tower air intake.

According to a further embodiment of the invention, the cooling air comprises a mixture of air taken in through a front assembly air intake and tower air taken in through a tower air intake located at a base portion of the tower, wherein the tower air is guided up through the tower and heated by power cables extending within the tower such that the relative humidity of the tower air is lower than the relative humidity of the air taken in through the front assembly air intake.

It is noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless otherwise indicated, in addition to any combination of features belonging to one type of subject matter also any combination of features relating to different subject matters, in particular to combinations of features of the method type claims and features of the apparatus type claims, is part of the disclosure of this document.

The aspects defined above and further aspects of embodiments of the present invention are apparent from the examples of embodiments to be described hereinafter and are explained with reference to the examples of embodiments. The invention will be described in more detail hereinafter with reference to examples of embodiments. However, it is explicitly noted that the invention is not limited to the described exemplary embodiments.

### BRIEF DESCRIPTION

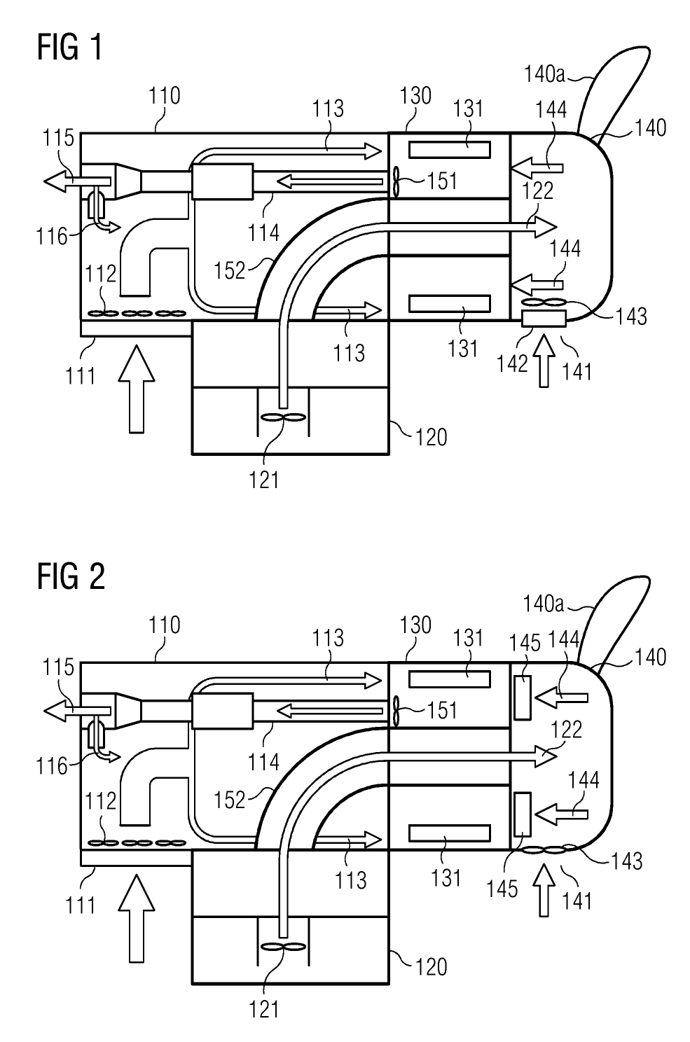

FIG. 1 shows a wind turbine;

FIG. 2 shows a wind turbine;

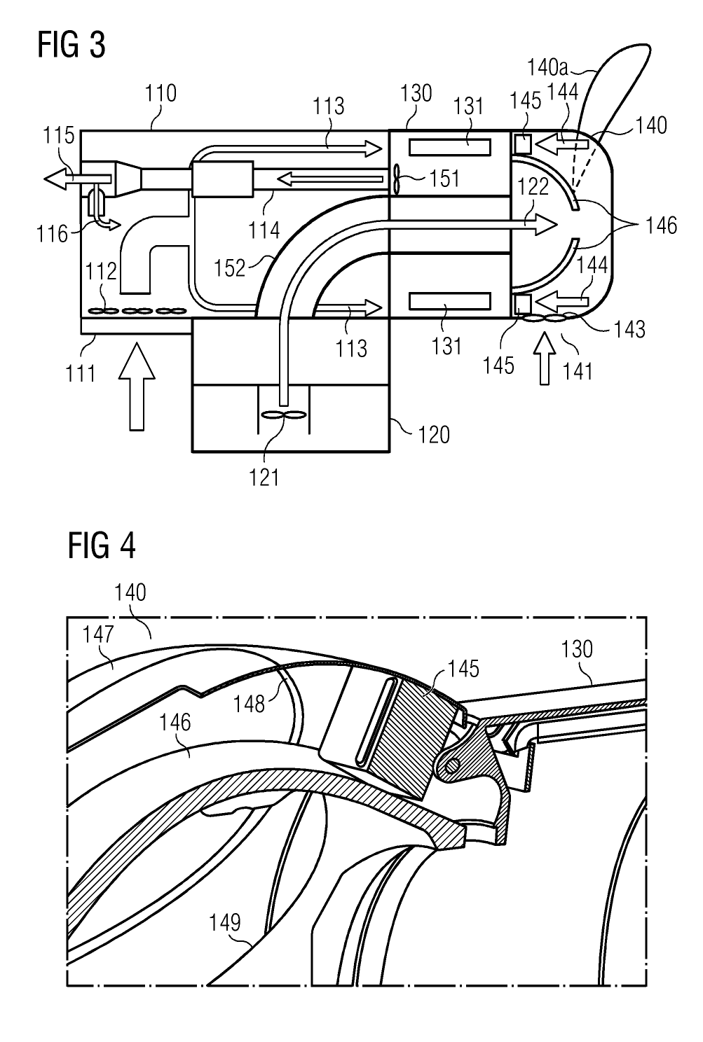

FIG. 3 shows a wind turbine;

FIG. 4 shows a first partial view of a rotatable front assembly of a wind turbine;

FIG. 5 shows a further partial view of the rotatable front assembly shown in FIG. 4;

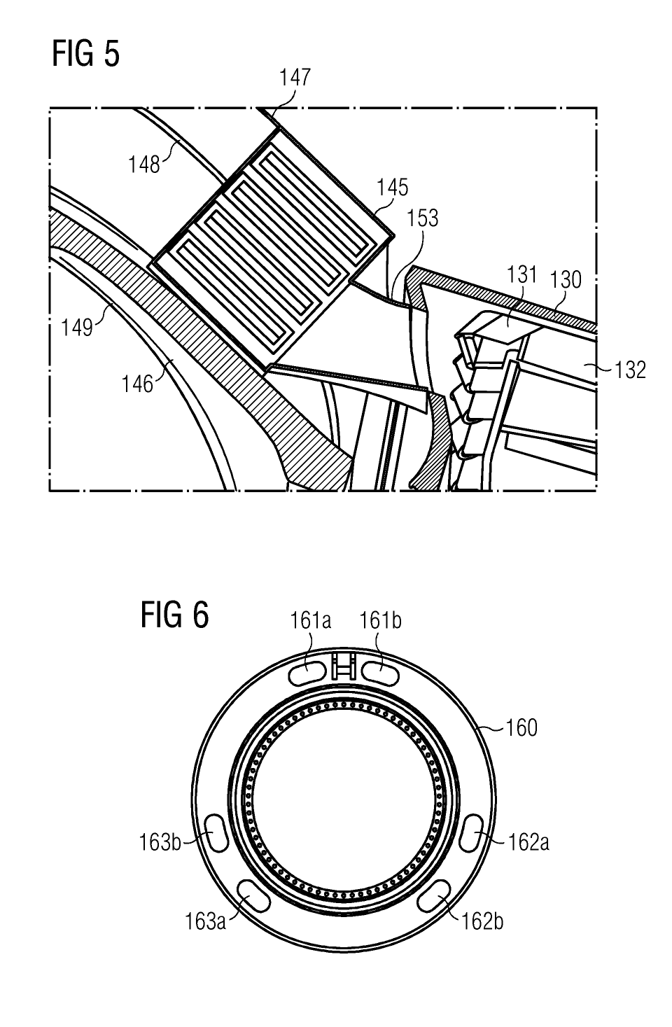

FIG. 6 shows a rotor front plate of a wind turbine;

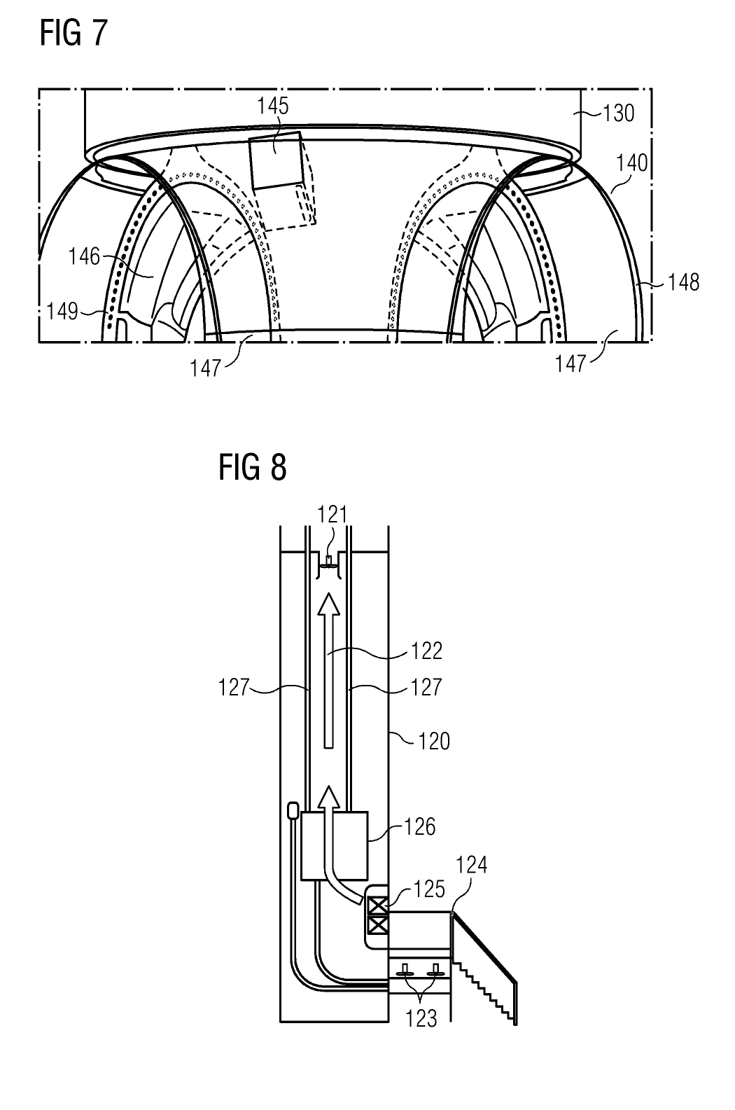

FIG. 7 shows a further partial view of the rotatable front assembly shown in FIGS. 4 and 5;

FIG. 8 shows a tower of a wind turbine;

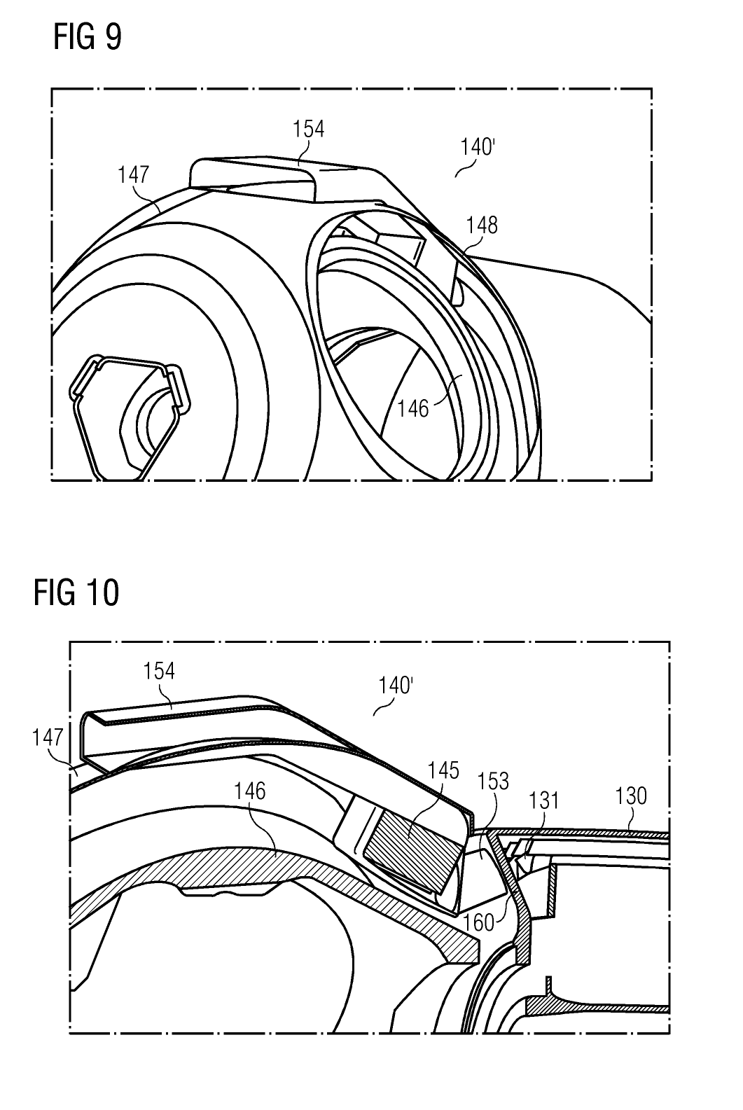

FIG. 9 shows an overview of a rotatable front assembly of a wind turbine;

FIG. 10 shows a detailed view of a part of the rotatable front assembly shown in FIG. 9.

### DETAILED DESCRIPTION

Some of the embodiments will be described in detail, with reference to the following figures, wherein like designations denote like members, wherein:

FIG. 1 shows a wind turbine according to an embodiment of the invention. The wind turbine comprises a nacelle 110 mounted on top of a tower 120, a generator comprising a rotor 130 with magnets arranged to rotate around generator windings 131 mounted on a stator 132 (shown in FIG. 5), and a rotatable front assembly 140 arranged on the side of the generator 130, 131, 132 that is opposite to (i.e. facing away from) the nacelle 110. The rotatable front assembly 140 comprises at least one rotor blade 140a, preferably three rotor blades 140a. It is noted that the wind turbine shown in FIG. 1 is a direct drive wind turbine. However, embodiments of the present invention are equally applicable to other types of wind turbines, such as gear drive wind turbines.

The wind turbine further comprises a cooling system for cooling the generator 130, 131, 132, in particular the generator windings 131, 132, by feeding cooling air 144 from the rotatable front assembly 140 into the generator 130, 131, 132. The cooling air 144 is obtained through front assembly air intake 141, or as tower air 122 which is guided from the tower 120 through tower air guiding means 152, such as a pipe. The cooling air may also be a blend of air taken in through the front assembly air intake 141 and tower air 122. In the latter case, the tower air 122 may in particular be useful for reducing the humidity of the cooling air 144, as will be described in more detail below in conjunction with FIG. 8.

An inlet filter 142, such as a moisture filter, dirt filter, salt filter or a combination thereof, is arranged in the air intake 141 to filter the ambient air that is taken into the front assembly 140. Optionally, an inlet fan 143 may also be arranged in the vicinity of the air intake 141.

The cooling air 144 is guided into the generator 130, 131, 132 through suitable openings connecting the rotatable front assembly 140 and the generator 130, 131, 132. As will be discussed in more detail further below in conjunction with FIG. 6, the openings may in particular be formed in a rotor front plate. A rear fan 151 arranged in the vicinity of an interface between the generator 130, 131, 132 and the nacelle 110 draws the cooling air 144 through the generator 130, 131, 132. After being circulated within the generator 130, 131, 132, in particular in the vicinity of the generator windings 131, the cooling air 144 leaves the generator 130, 131, 132 and passes through an exhaust guide 114 in the nacelle 110 before it leaves the nacelle 110 as exhaust air 115.

In an optional modification of the embodiment, cooling air 113 may also be supplied from the nacelle 110 into the generator 130, 131, 132. For this purpose, ambient air is taken into the nacelle through filer 111 with support from fans 112 and guided into the generator 130, 131, 132 as shown in FIG. 1. The humidity of the nacelle cooling air 113 may be reduced by means of exhaust air bypass 116 which bypasses a part of the exhaust air 115 into the nacelle where it is mixed with the air taken in through filter 111.

It is explicitly noted that although FIG. 1 only shows one front assembly air intake 141, the front assembly 140 may comprise any number of air intakes 141, in particular two, three, four or even more air intakes 141.

FIG. 2 shows a wind turbine according to a further embodiment of the invention. More specifically, the embodiment shown in FIG. 2 only differs from the embodiment shown in FIG. 1 and discussed in detail above in that the intake filter 141 is replaced by filters 145 arranged in the vicinity of the openings or connections between the rotatable front assembly 140 and the generator 130, 131, 132. Accordingly, in this embodiment the filtering of the air takes place where the cooling air 144 enters the generator 130, 131, 132 instead of where ambient air enters the rotatable front assembly 140. In a modification of the embodiment shown in FIG. 2, both an inlet filter 142 as the one shown in FIG. 1 and the filters 145 shown in FIG. 2 may be used.

With regard to the remaining structure of the wind turbine shown in FIG. 2, reference is made to the corresponding description in relation to FIG. 1 above.

FIG. 3 shows a wind turbine according to a further embodiment of the invention. More specifically, the embodiment shown in FIG. 3 is a modification of the embodiment shown in FIG. 2 and discussed above. In addition to the elements shown in FIG. 2, the front assembly 140 in FIG. 3 is shown as including a hub 146 for supporting the rotor blade(s) of the wind turbine (not shown). Here, the filters 145 are arranged between the outer surface of the hub and close to the outer wall or cover (also referred to as the spinner) of the front assembly 140. The tower air 122 is guided through the hub 146 to blend with the ambient air taken in through air intake(s) 141.

FIG. 4 shows a first partial view of a rotatable front assembly of a wind turbine in accordance with an embodiment of the invention. More specifically, FIG. 4 shows the rotatable front assembly 140 comprising spinner (or cover) 147 and hub 146. The spinner 147 comprises an opening 148 for letting a rotor blade (not shown) through. The hub 146 comprises an opening or mounting portion 149 in which the rotor blade is to be mounted. The filter 145 is arranged between the spinner 147 and the hub 146 close to an opening into the generator 130, 131, 132. Thereby, ambient air may be taken in through the blade opening 148 and pass through the filter 145 and into the generator 130.

FIG. 5 shows a further partial view of the rotatable front assembly 140 shown in FIG. 4. In particular, FIG. 5 shows an air guide 153 arranged on the side of the filter 145 facing the generator 130, 131, 132 for guiding the filtered cooling air into the generator 130, 131, 132 in order to cool the generator windings 131.

With regard to FIGS. 4 and 5, it is noted that the spinner 147 and hub 146 may be designed to receive and hold more than one rotor blade, in particular three rotor blades. Furthermore, a plurality of filters 145 may be arranged around the perimeter of the generator rotor 130.

In a modification of the embodiment shown in FIG. 5, a front assembly air intake may be formed in the gap between the front assembly 140 and the generator 130, e.g. above the air guide 153. In this case, ducts or pipes will additionally be formed between the gap and the spinner 147 or the spinner-sided air-intake of the filter(s) 145 in order to transport the air taken in towards the front of the front assembly 140 (i.e. towards the left side (i.e. air-intake side) of filter 145 in FIG. 5), such that the air can be sent through the filter 145, into the air guide 153 and further into the generator 130 as discussed above.

FIG. 6 shows a rotor front plate 160 of a wind turbine in accordance with an embodiment of the invention. The front rotor plate 160 designed to be arranged at the drive end of the generator 130, i.e. facing the rotatable front assembly 140, on the rotor of the generator 130 which rotates around the windings 131 to induce electrical currents therein. As shown, the front rotor plate 160 comprises three pairs of holes or openings 161a, 161b, 162a, 162b, 163a, 163b arranged close to the perimeter of the front rotor plate 160. Each opening 161a, 161b, 162a, 162b, 163a, 163b may be connected with a corresponding filter 145 and a corresponding air guide 153 in the way shown in FIG. 5.

It is noted that FIG. 6 also shows a cut-out formed between the openings 161a and 161b. The cut-out is shaped to interact with a lifting tool during assembly of the wind turbine. Due to the large forces and stress that may occur during assembly, it may be advantageous to leave out the pair of openings 161a and 161b (which may otherwise be deformed during assembly) and instead increase the size of the other openings 162a, 162b, 163a, 163b.

FIG. 7 shows a further partial view of the rotatable front assembly shown in FIGS. 4 and 5. In particular, the view of FIG. 7 shows that the hub 146 comprises three blade mounting portions 149 and that the spinner 147 comprises three corresponding blade openings 148. Although only a single filter unit 145 is shown (for reasons of clarity), a total of six filter units 145 may be implemented and arranged as discussed in connection with FIG. 6 above.

FIG. 8 shows the tower 120 of a wind turbine according to an embodiment of the invention, in particular according to any of the embodiments described above or below. As shown, the tower 120 comprises a tower fan 121 arranged at an upper portion of the tower for drawing tower air 122 upwards (towards the nacelle) within the tower 120. The tower air 122 is taken into the tower 120 in the area of tower entrance 124. The air intake may be supported by lower fans 123. The air entering the tower is filtered by filters 125 and passed by electrical installations 126. On its way towards the fan 121 at the top of the tower, the air is heated by heat emitted by power cables 127. The power cables 127 transmit electrical power generated by the generator to the electrical installations 126, such as transformer, converter etc. Accordingly, once the tower air 122 reaches the top of the tower 120, it is warmer and relatively dry, i.e. it has a lower relative humidity than the surrounding air. Accordingly, the tower air 122 will be highly suitable for cooling and/or dehumidifying the cooling air 144 supplied to the generator from the rotatable front assembly as described above. Simultaneously, the temperature of the cooling air 144 supplied to the generator will be increased to some extent. The humidity and the temperature of the cooling air 144 arriving at the generator can thus be controlled by the amount of tower air 122 provided by the fan 121 and/or fan 125 at the bottom or the top of the tower 120.

FIG. 9 shows an overview of a rotatable front assembly 140′ of a wind turbine in accordance with an alternative embodiment of the invention. The rotatable front assembly 140′ of this embodiment differs from the rotatable front assembly 140 described in conjunction with the previous embodiments in that ambient air is not taken in through the blade opening 148 but instead through an air guide 154 arranged on the outer surface of the spinner 147. The air guide 154 is formed as a rectangular, relatively flat conduit extending over the surface of the spinner 147 in such a way that the opening faces the incoming wind. Thereby, ambient air can easily be drawn into the rotatable front assembly 140′ and fed into the generator 130 to cool the generator windings 131.

FIG. 10 shows a detailed view of a part of the rotatable front assembly 140′ shown in FIG. 9. As shown, ambient air is taken in through the air guide 154 and guided through the filter 145 and into the generator 130 by the air guide 153 extending through the front rotor plate 160.

It is noted that the term “comprising” does not exclude other elements or steps and the use of the articles “a” or “an” does not exclude a plurality. Also elements described in association with different embodiments may be combined. It is further noted that reference signs in the claims are not to be construed as limiting the scope of the claims.

1. A wind turbine comprising: a nacelle supported by a tower, a generator, a rotatable front assembly arranged on a side of the generator facing away from the nacelle, and a cooling system for cooling the generator by feeding cooling air from the rotatable front assembly to the generator.

2. The wind turbine according to claim 1, wherein the rotatable front assembly comprises a front assembly air intake, and wherein the cooling air comprises air taken in through the front assembly air intake.

3. The wind turbine according to claim 2, wherein the rotatable front assembly comprises a hub, at least one rotor blade mounted on the hub, and a spinner covering the hub.

4. The wind turbine according to claim 3, wherein the front assembly air intake is at least partially coincident with an opening in the spinner through which the at least one rotor blade extends.

5. The wind turbine according to claim 4, wherein the front assembly air intake (141) comprises a ring-shaped opening surrounding the at least one rotor blade (140a).

6. The wind turbine according to claim 3, wherein the front assembly air intake comprises an air guide arranged on an outer surface of the spinner.

7. The wind turbine according to claim 2, wherein the front assembly air intake comprises an intake filter and/or an intake fan.

8. The wind turbine according to claim 1, wherein the tower comprises a tower air intake located at a base portion of the tower and power cables for transmitting power from the generator to the base portion, and wherein the cooling system comprises means for guiding air from the tower air intake to the rotatable front assembly such that the air is heated by the power cables, whereby the cooling air comprises air taken in through the tower air intake.

9. The wind turbine according to claim 2, wherein the tower air reduces the relative humidity of the cooling air.

10. The wind turbine according to claim 8, wherein the cooling system further comprises a tower fan arranged within the tower.

11. The wind turbine according to claim 1, wherein the rotatable front assembly comprises one or more openings facing the generator, the openings being adapted to feed the cooling air to the generator.

12. The wind turbine according to claim 11, wherein a filter is arranged in the vicinity of each of the one or more openings.

13. The wind turbine according to claim 12, wherein the filter arranged in each of the one or more openings is selected from the group consisting of a moisture filter, a dirt filter, and a salt filter.

14. The wind turbine according to claim 1, wherein the cooling system further comprises a rear fan arranged at a side of the generator facing away from the rotatable front assembly, the rear fan being adapted to draw the cooling air from the rotatable front assembly through the generator and towards the nacelle.

15. The wind turbine according to claim 1, wherein the cooling system is further adapted to feed additional cooling air from the nacelle to the generator.

16. A method of cooling a generator of a wind turbine, the wind turbine comprising a nacelle supported by a tower, the generator, and a rotatable front assembly arranged on a side of the generator facing away from the nacelle, the method comprising feeding cooling air from the rotatable front assembly to the generator.

17. The method according to claim 16, wherein the cooling air comprises a mixture of air taken in through a front assembly air intake and tower air taken in through a tower air intake located at a base portion of the tower, wherein the tower air is guided up through the tower and heated by power cables extending within the tower such that the relative humidity of the tower air is lower than the relative humidity of the air taken in through the front assembly air intake.
